(19) United States
(12) Patent Application Publication
(10) Pub. No.: US 2008/0005111 A1
(43) Pub. Date: Jan. 3, 2008

(54) ATOMIC TRANSACTION FILE MANAGER

(75) Inventor: Kevin J. Savage, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/382,248

(22) Filed: May 8, 2006

(51) Int. Cl. G06F 17/30

(52) U.S. Cl. 707/8

(57) ABSTRACT

Embodiments provide developers with easy to use file atomicity mechanisms and undo/redo functionality that are not tied to any particular document format by using modern file systems. More specifically, a transaction file manager is configured to automatically utilize a directory name change operation to ensure the atomicity of file modifications (i.e., a change to one file is either consistently applied across all files within the directory, or not at all) without regard to any particular file format. Further, to support versioning of changes to multiple files, embodiments also keep the order of sets of changes by using a sortable directory naming mechanism within the transaction file manager. Most modern file system will allow for these two things, thus providing a system that atomically applies changes across arbitrary sets of files using any file format, while also providing multilevel undo/redo functionality.

### CROSS-REFERENCE TO RELATED APPLICATIONS

N/A

### BACKGROUND

Computerized systems provide many advantages towards peoples' ability to perform tasks. Indeed, the computer system's capacity to process information has transformed the way we live and work. Computers now aid in enumerable applications such as word processing, computer simulations, advanced gaming, voice recognition, and much more. Moreover, computing systems now come in a wide-variety of forms including, for example, desktop computers, laptop computers, Personal Digital Assistants (PDAs), and even mobile telephones and other devices.

Most of today's computing systems include a file system that incorporates a multitude of different types of files for different types of applications and usage. Quite frequently, the problem arises that data from these multiple files on a single disk are somehow related, and the modification to one file may imply a desire for modification to a different, related file. Further, it may be important to ensure that there is no inconstancy between files after such modifications. As such, customers may expect atomic data integrity to be maintained across multiple files despite catastrophic failures in hardware and/or software. In other words, often times it is desirable to ensure the atomicity of the files such that a write operation is either entirely performed on each related file, or not at all—even in the event of a hardware and/or software failure.

Take for example the design and implementation of a product for consumption. A development schedule may appear in a spreadsheet document and a technical specification may be stored in a text editing document. As can be appreciated, both of these documents need to be kept in sync. More specifically, the technical specification might call out work items that also need be reflected in the spread sheet development schedule, and vice versa. As such, it is important to ensure that changes to one document get reflected in the other document even in the event of computing failures.

Modern file systems typically do not provide for transactions (i.e., write operations) across multiple files, so developers are on their own when it comes to handling these cases. This can be a very challenging thing to implement, especially if atomic data integrity is desired. For example, one solution might be for a developer to combine both files into a single file and then use the file name change operation to ensure atomicity when making changes to that file. Such integrity, however, may not be possible given functional requirements of the particular computing system. For instance, in the case of a text and spreadsheet document, these file formats typically cannot be combined into one file without losing the ability to edit them in the opposite format and/or without writing an extensive amount of import/export code.

As an alternative, a developer may attempt to provide a check-summing so that inconsistencies can be detected and corrected. In such an approach, hashes or other representations of the data within each file may be used to determine changes made to other related files, and mechanisms can be developed for determining specific changes for keeping the files in sync. Similar to above, however, this approach also requires file format changes that may not be possible since the developer who is writing the application may not control the file format. In addition, a large amount of coding would be required to implement such an approach, especially across multiple file formats—which again may or may not even be possible.

Another option might be to use a database that supports multi-file transactions. Similar to those techniques described above, however, this mechanism may not be conceivable given the functional requirements of an application. Further, this approach is not trivial to implement since it involves coming up with the right schema, writing database client code, etc. Accordingly, all of the above solutions identified are labor intensive, require a great deal of processing resources, and may be tricky to implement and develop.

In addition to keeping related multi-file atomicity, it is also desirable to support multiple levels of undo/redo across changes to such files. To briefly summarize, users often make mistakes during data entry and need to be able to revert changes, and also undo such changes. As will be easily recognized, such undo/redo functionality has great value, but typically requires extensive coding and other sophisticated file formatting in order to appropriately be implemented.

### BRIEF SUMMARY

The above-identified deficiencies and drawback of current computing filing systems are overcome through example embodiments of the present invention. For example, embodiments described herein provide for ensuring atomicity for multiple writes to document(s) without regard to any particular document format type and without creating complex code for syncing document fields. In addition, other embodiments provide for multiple levels of undo/redo functionality for changes to document(s) without regard to any particular file format type. Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example embodiment provides for ensuring atomic consistency across multiple writes to document(s) without regard to any particular document format type. In this embodiment, a file transaction initialization is received for making multiple writes to file(s) located within a first directory of a file system. The file transaction is then identified as requiring atomicity across multiple writes to the file(s) such that the multiple writes either succeed or fail as a whole even with hardware and/or software failures. Based on the required atomic consistency, a temporary directory folder different from the first is automatically created. Note that the temporary directory folder is used to save in-memory data to the file(s) for making the multiple writes thereto.

Another example embodiment provides for multiple levels of undo/redo functionality for changes to document(s) without regard to any particular document format type by using a sortable directory mechanism. In this embodiment, user input is received requesting an undo/redo change to a set of files. Note that the set of files are atomically maintained such that a change to one file must either be consistently applied to each file within the set, or not at all. Thereafter, a set of directories related to the set of file(s) is accessed. Each of the set of directories includes an atomic set of the files that were committed to permanent storage such that each directory within the set represents a version or writes that were atomically maintained across the set of files. Based on the user input, a chosen directory is selected from the set of directories for accessing a particular version of the set of files in order to apply multiple levels of the undo/redo changes as desired.

In another example embodiment, a system is provided for protecting against hardware and/or software failures by rolling back to a previous version of a set of documents based on a transaction that only partially completed. Similar to above, an initialization for a file transaction is received for a set of files, which are atomically maintained such that a change to one file must either be consistently applied to each file within the set, or not at all. Based on the initialization, a storage that includes a temporary directory and a first directory for different versions of the set of files is accessed. Note that the temporary directory was automatically created from a previous file transaction initialization that made a change to one of the files from the set, while the first directory includes a copy of the set of files without the change to any file therein. Thereafter, it is identified that the file transaction abnormally terminated, which indicates that one of the files from the set within the temporary directory does not include the change such that this change has not been atomically applied to each of the files within the set. Accordingly, the committed directory is used for the file transaction such that set of files rolls-back to the version without the change to any file within the set.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a transaction file manager used for ensuring atomicity across multiple writes to document(s) in accordance with example embodiments;

FIG. 2 illustrates a file system used for undo/redo functionality for changes to documents in accordance with example embodiments;

FIG. 3 illustrates a flow diagram of a method of ensuring atomic consistency for multiple writes across document(s) without regard to any particular document format type in accordance with example embodiments;

FIG. 4 illustrates a flow diagram of a method of providing multiple levels of undo/redo functionality for changes to documents in accordance with example embodiments; and

FIG. 5 illustrates a flow diagram for a method of protecting against hardware and/or software failures by rolling back to a previous version of a set of documents based on a transaction that only partially completed in accordance with example embodiments.

### DETAILED DESCRIPTION

The present invention extends to methods, systems, and computer program products for ensuring atomicity and providing multilevels of undo/redo functionality for multiple writes across document(s) without regard to any particular document format type and without creating complex code for syncing document fields. The embodiments of the present invention may comprise a special purpose or general-purpose computer including various computer hardware or modules, as discussed in greater detail below.

The above-identified deficiencies and drawbacks of current filing systems are overcome through embodiments that provide developers with easy to use mechanisms that are not tied to any particular document format and that ensure consistency across multiple writes to multiple documents (or even a single document) using modern file systems. Embodiments provide for a transaction file manager configured to automatically utilize a directory name change operation to ensure the atomicity of file modifications (i.e., a change to one file is either consistently applied across all files within the directory, or not at all) without regard to any particular file format. Existing code provided by developers that attempts to keep changes or writes to files consistent may utilize embodiments described herein; however, files for such existing schemes should typically be written to a directory provided by the transaction file manager (whose root path may be supplied by the developer (or other) using this scheme).

To support versioning of changes to multiple files, embodiments also keep the order of sets of changes by using a sortable directory naming mechanism within the transaction file manager. This embodiment assumes the atomicity of the directory name change operation described above, and also ensures the order of directory name changes (or some other identifier) so that the sort order of the directory names can be used as a versioning scheme.

Most modern file system will allow for these two things, thus providing a system that atomically applies changes across arbitrary sets of files using any file format, while also providing multilevel undo/redo functionality. As such, minimal modifications may be needed to existing applications, which provides a large advantage in terms of development time savings over attempting an approach customized for a particular application (i.e., embodiments provide for atomicity across multiple writes to a set of files, without regard to a particular file format and without creating complex code for syncing document fields). Although in some instances, this mechanism may not be a first choice depending upon the size of the file and performance requirements of a particular user, with modern disk speeds this approach is a viable option that provides significant develop time savings.

Although more specific reference to advantageous features are described in greater detail below with regards to the Figures, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

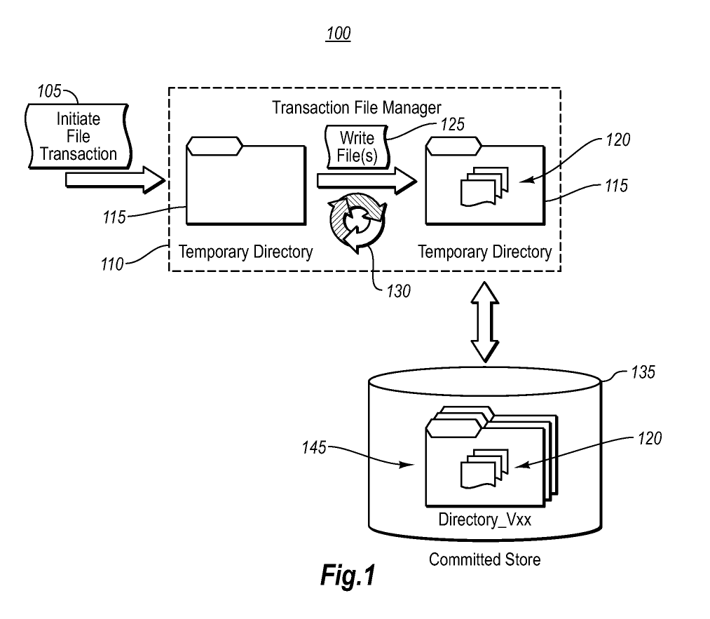

FIG. 1 illustrates a system for protecting the integrity of changes across multiple files of potentially different and arbitrary file formats in accordance with embodiments herein described. As shown, a computing or filing system 100 includes a transaction file manager 110 that monitors the writes or modifications to files or documents of various format types. In this embodiment, a notice 105 is received to initiate a file transaction, which may be any well known transaction type, e.g., creating a file, opening a file, editing a file, closing a file, or any other mechanism for activating a file for making changes thereto.

Note that the file or documents formats may be any arbitrary type of text document, spreadsheet, or other file format that includes data that can be modified. Nevertheless, it is worth noting that embodiments are not directed towards providing mechanisms for identifying what data needs to be changed within various types of documents. Rather, embodiments currently described are directed towards ensuring the atomicity of a set of files through a directory naming and management system. In other words, embodiments protect the integrity of changes across multiple files of potentially different and arbitrary file format, without having to make extensive modifications to the part of software that performs writes on individual files. The only requirement is that these files get written out to a specific directory as described below.

In any event, upon initiation of the file transaction 105, transaction file manager 110 automatically creates a temporary directory 115 (e.g., named as “Directory_VTemp”). Note that typically a developer will specify the naming convention used for the transaction set, thus providing a root path for the temporary 115 and other such directories managed by the transaction file manager 110. For example, typically when initializing a transaction a user will specify the file group name and root directory prior to executing a set of related transactions. However, in other embodiments the group file name and root directory or path may be a default one defined by the transaction file manager 110 or otherwise provided in any other well known manner.

Upon initialization of a file transaction 105, the transaction file manager 110 searches the committed store 135 or otherwise looks for a previous transaction that may have only partially completed during some form of hardware or/and software failure (which is typically a catastrophic failure that causes the system to crash). The transaction file manager 110 then returns a Boolean to the user indicating if any intact versions where found. If a partially intact version is discovered, transaction file manager 110 is also configured to rollback the partially completed transactions such that the consistency is ensured for files that are to be atomically maintained. In other words the transaction file manger 110 determines what version of a directory 145 within committed store 135 should be used when the file transaction 105 is initiated based on the atomicity needed for the desired files (i.e., changes must consistently be applied among all files, or not at all).

Note that although typically the atomic changes as described herein appear across multiple files, there may be instances when changes for a single file must also atomically be applied. For example, there may be instance where a set of data needs to be included within a file, or otherwise the data should not appear at all if any one piece of the data is missing within the file. As such, embodiments described herein also contemplate using the directory name changing mechanism for ensuring atomicity of multiple writes (as well as the undo/redo functionality described below) to a single document in order to protect against hardware and/or software failures. Although the following description will typically refer to the data atomicity and other operations for multiple related files, such reference is used herein for illustrative purposes only and is not meant to limit or otherwise narrow the scope of embodiments unless explicitly claimed. In addition, it should be noted that the changes or writes 130 may refer to creation of files 120, as well as modification to existing files 120. Accordingly, when describing modification or changes made to files, such descriptions should be broadly construed to include the addition or creation of files, which relate to other files within the system that needed to be synced.

In any event, once the file set is identified that the file transaction 105 is directed towards, a temporary directory 115 is automatically created for making writes to the corresponding files. Accordingly, as writes 125 are made the temporary directory 115 is filled with copies of the documents 120 with the appropriate changes made thereto. These writes to the files 120 are repeated as indicated in recycling indicator 130 until either all of the files have been appropriately modified or updated 120, the developer or user indicates that the writes should be committed, and/or some catastrophic hardware and/or software failure occurs. In the event that the write file(s) 125 have been consistently or atomically applied 130 to all the appropriate related files 120, and/or the developer otherwise indicates that the writes should be committed, the temporary directory 115 can be committed to store 145 and renamed to a particular directory version 145 as will be described in greater detail below.

In other words, upon the initiation 105 of a transaction, the transaction file manager 110 creates a temporary directory 115 in a root path of a directory typically provided by the developer, wherein the full path of the temporary directory 115 may be returned to the caller. The developer or application uses the temporary directory 115 for saving in-memory data to multiple, related on-disk files during the transaction 130. When satisfied, the user can tell the transaction file manager 110 to commit the transaction, wherein a new version name (or other renaming mechanism) for the committed directory 145 is created based off the transaction set name and a current version known to the transaction file manger 110. That is, the temporary directory 115 is renamed to the new version name (in this instance “Directory_Vxx”, where “xx” indicates a specific version type) when committed, thus atomically maintaining the file changes across the multiple or single files as previously described.

Note that although a versioning name was used for the renaming mechanism, embodiments herein may also apply to other naming conventions. Accordingly, the use of the renaming to specific versions based on a previous version name as described herein is for illustrative purposes only and is not meant to limit or otherwise narrow the scope of embodiments unless explicitly claimed. Nevertheless, as will be described in greater detail below, using a versioning type naming provides for a sortable (e.g., numerical) naming convention that may be used for rollback and other undo/redo purposes.

As mentioned above, the transaction file manager 110 also includes a rollback mechanism for catastrophic or other hardware and/or software failures. Rather than committing the transaction described above, the developer may wish to rollback to a previous version. In such instance, the transaction file manager 110 provides rollback functionality that can be called after the transaction start, but in lieu of transaction commit (where the renaming of the temporary directory 115 occurs). Typically, in such rollback situation, the transaction file manager 110 deletes the temporary directory 115 along with all of its contents 120.

Also note that if upon initialization of a file transaction 105, transaction file manager 110 determines that a temporary directory 115 already exists, the transaction file manager 110 may assume that a catastrophic or other hardware and/or software failure occurred. In other words, it may be assumed that a previous transaction only partially completed, indicating that atomicity does not exists across the files (or file) as desired. In such case, the temporary directory 115 should be removed. The transaction file manager 110 can now access the last (or other) known good committed directory 145, if one exists. Note, however, that typically a catastrophic hardware and/or software failure will cause the temporary directory 115 to automatically be lost, so there may not be a need for this rollback feature. Instead, the transaction file manager 110 simply identifies the latest directory version used or committed 145 and reports this to the user or otherwise uses it 145 for completing the transaction request 105.

It should be noted that one way to determine that a file transaction 105 abnormally terminated is by identifying the presence of a temporary directory 115 while not presently processing a transaction 105 (either at the beginning of a transaction or at some other time). As such, the consistency and atomicity across file operations for the previous transaction cannot be guaranteed. In other words, a simple way to determine if the previous transaction 105 failed is to see if the temporary directory 115 exists, e.g., at the beginning of a new transaction 105. This enables the transaction file manager 110 to determine the hardware and/or software failure without having to understand anything about the contents of the directory, which can be left to the application (user) making the changes. This mechanism if very powerful because it requires far less modification to the application (user) code in order to integrate with the transaction file manager 110. Nevertheless, other embodiments herein are not limited to identifying hardware/software failures in this particular manner, and other well known mechanisms and techniques are also contemplated herein for identifying when not to trust the data within a temporary directory 115.

Further note that there may be other instances in which the transaction file manager 115 may implement the rollback functionality described herein. For example, the transaction file manager 110 may run a background task that has a global component that goes and checks for the existence of other left-over files from different sets of transaction operations (i.e., files that were part of a previous transaction that were not committed). Accordingly, in summary, there are generally three instances that transaction file manager 110 might perform a rollback operation, which include: (1) upon initiation of a new transaction when it notices that a temporary directory 115 from a previous transaction is hanging around; (2) when the user explicitly calls cancel/rollback to the transaction file manager 110 in the middle of a transaction 105; and (3) as a background task that a running transaction file manager 110 might perform after it has been initialized. Nevertheless, there may be other instances in which the rollback functionality may be implemented. Accordingly, the above list of instances for when this rollback feature is advantageously used is not meant to be exhaustive; and therefore is not meant to limit or otherwise narrow the scope of embodiments unless otherwise explicitly claimed.

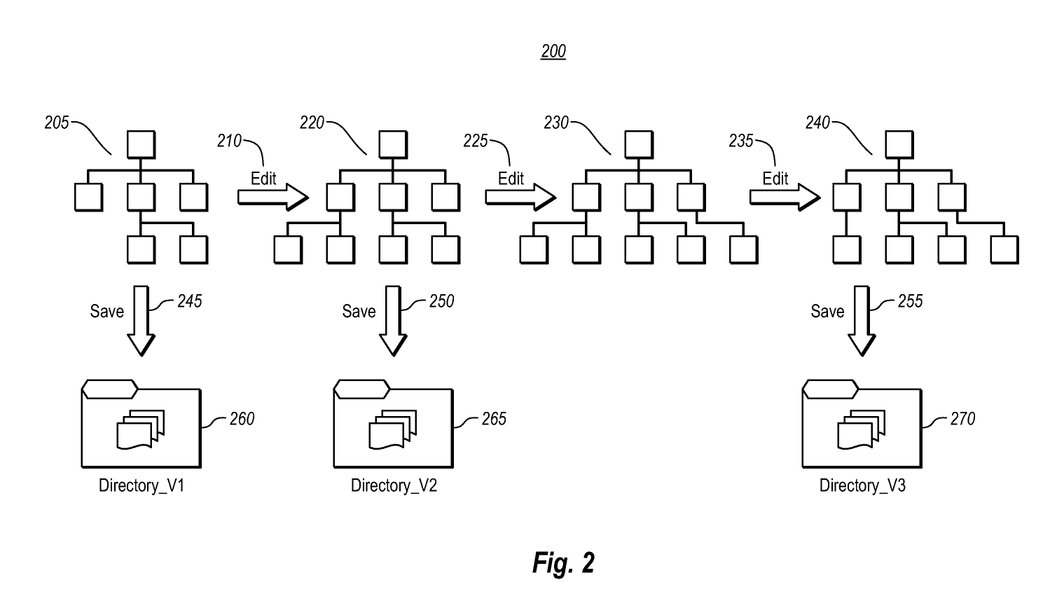

Embodiments also provide for an undo/redo mechanism that can advantageously flip-flop directories to a particular version as desired. For example, as shown in FIG. 2, a computing system 200 includes various data structures that are changed in accordance with embodiments described previously above. For example, data structure 205 in a first form can be saved 245 to a directory 260 under the version naming convention “Directory_V1”, where “V1” indicates the first committed version in the committed store 135. Data structure 205 can then be edited 210 to create a new data structure 220 that is then saved 205 in committed store 135 as directory 265 named “Directory_V2.” Note that typically the root path for these directories 260, 265 will be the same. Further, other edits 225 can be made to data structure 230 that may or may not be committed or otherwise saved. Nevertheless, in this example further edits 235 produce a third data structure 240 that can be then saved 255 as “Directory_V3” 270.

A user may now be presented with an application interface providing various options to switch between the three directories (i.e., Directory_V1 260, Directory_V2 265, and Directory_V3 270) as desired. Note that although the naming convention is used to identify the various versions of the directories, other mechanisms such as time and date and any other well known naming schemes or identifiers could be used for determining and presenting a user with options for undo/redo purposes. For instance, rather than using numerals for the various versions, the version may be listed in alphabetical order or have any other conventional marking mechanism to determine ordering of the directories. Accordingly, any particular naming convention or identifier used for undo/redo purposes described herein is for illustrative purposes only. Nevertheless, note that only committed versions of the data structures are saved as directory versions, and thus the user can be assured that the one or more files within the various directories are atomically maintained such that changes within one file occur across all of the files within that particular directory.

In the above embodiments, a developer or user may optionally decide to delete any of the previous versions in any particular order depending upon the requirements of an application or as the user desires. For example, the developer could opt to delete all but the latest version (committed last version), delete all but the earliest version (revert to the first version), and/or delete just the last version (revert one change backwards). Such options for which versions can be saved and delete may be based on configuration or other settings defined by the transaction file manager 110. Alternatively, or in conjunction, such options may be based on policy considerations or desires from the developer. For instance, the developer may set up policies that directories past a certain date or of a certain size should always be deleted. Of course, any of the various versions provided from the various directories can be saved and otherwise deleted as desired by the developer or user.

Note that the above approach protects the integrity of changes across multiple files (or potentially within a single file) of various and arbitrary file formats whose files are managed by the underlining file or transaction file manager 110. Accordingly, embodiments provide the ability to perform transaction file writes across multiple files of different file formats without having to make extensive modifications to particular software that performs writes on individual files—other then requiring that these files get written out to the same directory (which starts as a temporary directory 115 until committed 145).

Also, embodiments provide for the ability to retrofit an application fairly easily to support the above features using pre-existing implementations that use this approach. In other words, the multi-file transaction manager 110 can get called once prior to making multiple writes to start the transaction 105, and once at the end of the transaction 105. The code that writes out changes to individual files does not necessarily need to be modified, and no file format changes are necessarily required. Further note that no special file naming scheme is required. In fact, as mentioned above, the only need is for the writes to occur within a common directory (e.g., temporary directory 115), whose path and name are typically provided by the transaction file manager 110, while the upper components of the path may be specified by the developer who is using the transaction file manger 110.

Note that a potential limitation of some of the embodiments described herein is that typically related files are stored in a subdirectory partially managed by the transaction file manager 110, which may take away some control from the application and the user in terms of where files are saved. Accordingly, if this control is needed, other embodiments perform an initial copy or move of the relevant files to a directory managed by the transaction file manager 110 from the desired end location(s) for these files, followed by a final copy or move operation at the end of the transaction back to the desired location(s). Depending on the particular scenario, these initial and final moves/copies may not significantly detract from the benefits of the transaction file manager 110 and other embodiments described herein.

In addition, embodiments described herein provide the ability to support undo and redo without adding any additional restrictions in terms of file format changes, etc. Accordingly, this approach can be built upon to provide versioning support of undo/redo functionality to the end user.

The following provides some pseudo code for an application program interface (API) that gives an example of one that may be exposed to the developer and allow the functionality of the transaction file manager 110. Note that the following pseudo code is a representation of one API that may be used to practice embodiments describe herein; however, as one would appreciate there may be any number of similar type codes that can be used to implement various advantageous features as described herein. Accordingly, the following pseudo code and description thereof is used for illustrated purposes only and is not meant to limit or otherwise narrow the scope of embodiments herein.

Transaction File Manager API

Part 1 & 2
class FileTransactionManager : IDisposable

{

public FileTransactionManager( );

Part 3

/// <value>Lastest version</value>
public String LatestVersion;

Part 4

/// <value>Count of the number of versions</value>
public Int32 Count;

Part 5

/// <param name=“groupNameParameter”>Name to give to file group. Used as

the prefix to the file group versions, which are stored as directory names.</param>

/// <param name=“rootDirectoryParameter”>Root directory where the file group

will be stored.</param>

/// <returns>Whether prior versions were found.</returns>
public Boolean Initialize(

String groupNameParameter,
String rootDirectoryParameter);

Part 6

public void Dispose( );

Part 7

/// <returns>Temporary directory name where client should write any

files it wishes toinclude in the transaction</returns>

public String BeginTransaction( );

Part 8

/// Commits the transaction. The temporary directory is renamed to the next file

group version directory name</summary>

public void CommitTransaction( );

Part 9

public void RollbackTransaction( );

Part 10

/// <returns>True if one or more reverts were successful. False if there is nothing

to revert</returns>

public Boolean RevertToFirstVersion( );

Part 11

/// <returns>True if one or more reverts were successful. False if there is nothing

to revert</returns>

public Boolean RevertLatestVersion( );

Part 12

/// <returns>True if one or more reverts were successful. False if there is nothing

to revert</returns>

public Boolean EliminateAllButLatestVersion( );

Part 13

public void CollapseLastTwoCommits( );

}

Note that part one and two of the pseudo code creates an instance of the transaction file manager. In part three, the latest version of the directory or files may be returned. In this embodiment, any well known mechanisms for identifying the latest or desired version can be incorporated. For example, in the case where undo/redo or other various rollbacks has occurred, rather then acquiring the latest version, it may be desirable to mark some other current directory as including the desired files.

In part four of the pseudo code, the count of the number of versions may also be retrieved and presented to the user. Part five includes an initialize operation that is called prior to the beginning of a transaction initiation. The initialize operation allows the user to specify the root directory where subdirectories and files managed by the transaction file manager are placed and the name prefix/suffix for these subdirectories. Further, a Boolean indicator is returned for indicating whether previous versions from earlier sessions where found. If the client only calls initialize during application launch, this mechanism can be used to determine if a catastrophic or other error occurred and there is a recoverable earlier version. Accordingly, as described above, revert mechanism may be used to limit any temporary state from a transaction that was opened during a catastrophic event.

Part seven of the pseudo code starts the transaction such that a temporary directory is created using the file group name as a prefix. The temporary directory name may be returned to the caller, and the caller can prepend this directory name to the path of any file it wishes to include in the transaction. This temporary directory can then be used for saving in-memory data to multiple, related (if applicable) on-disk files in the transaction.

Part eight of the pseudo code then commits the transaction such that temporary directory is renamed to the next file group version directory name. As previously noted, this version directory name may be accomplished in any well known manner for identifying the various versions.

Part nine deletes any state associated with the open transaction for rollback or other purpose. Similarly, part ten provides a mechanism for deleting all versions except the earliest one for reverting back. Part eleven, on the other hand, will revert the latest version, thus allowing the current version to now be the previous version. Part twelve, on the other hand, eliminates all versions prior to the latest, thereby making the latest version the first and only version remaining. Accordingly, this command rolls-back the currently open transaction, if there is one. Finally, part thirteen overrides the second to last commit with the last commit. Similar to above, this command rolls-back to the currently open transaction, if there is one.

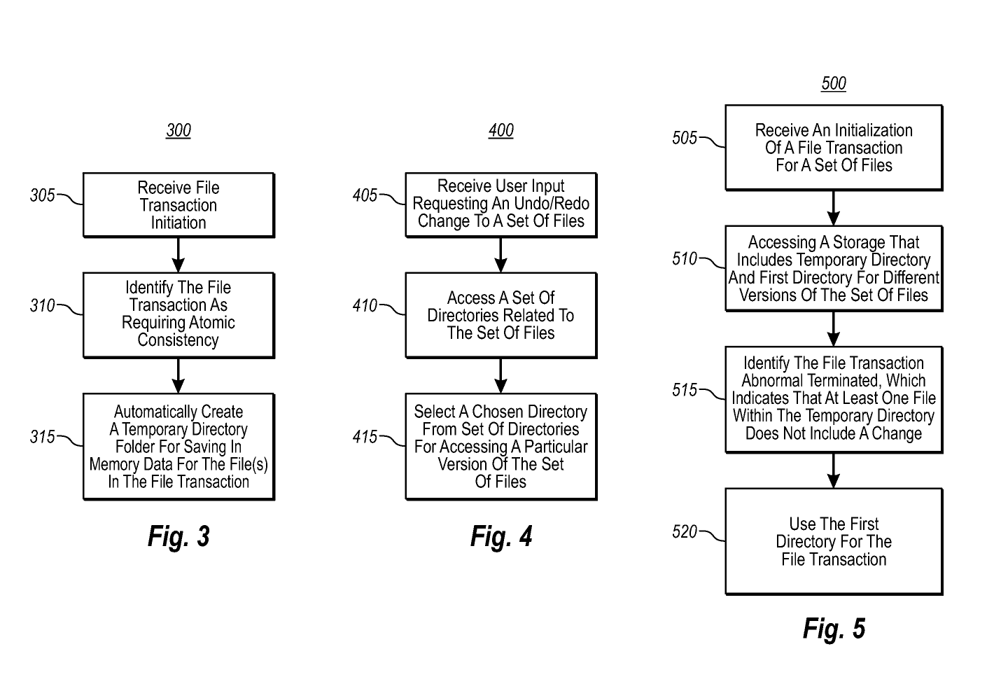

The present invention may also be described in terms of methods comprising functional steps and/or non-functional acts. The following is a description of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts in the recitation of the claims—and in the following description of the flow diagrams for FIGS. 3-5—is used to indicate the desired specific use of such terms.

As previously mentioned, FIGS. 3-5 illustrate flow diagrams for various exemplary embodiments of the present invention. The following description of FIGS. 3-5 will occasionally refer to corresponding elements from FIGS. 1 and 2. Although reference may be made to a specific element from these Figures, such references are used for illustrative purposes only and are not meant to limit or otherwise narrow the scope of the described embodiments unless explicitly claimed.

FIG. 3 illustrates a flow diagram for a method 300 of ensuring atomicity for multiple writes across document(s) without regard to any particular document format type and without creating complex code for syncing document fields. Method 300 includes an act for receiving 305 a file transaction initialization. For example, transaction file manager 110 may receive initiate file transaction request 105 for making multiple writes to file(s) located within a first directory (e.g., a committed directory 145 “Directory_Vxx”) of a file system 100. Method 300 also includes a step of identifying 310 the file transaction as requiring atomic consistency. For example, transaction file manager 110 can be used to determine that file(s) associated with the initiate file transaction 105 require atomicity across the multiple writes such that the multiple writes either succeed or fail as a whole even with a hardware and/or software failure.

Based on the required atomicity, method 300 further includes an act for automatically creating 315 a temporary directory folder for saving in-memory data for the file(s) in the file transaction. For instance, upon receiving initiate file transaction 105, transaction file manager 110 can automatically create temporary directory 115 folder (which is different from a directory 145 within committed store 135), which will be used for making the multiple writes 130 thereto. Note that when each of the multiple writes 130 are made to the file(s) (or when otherwise desired by the user or developer), a commit notification may be received that converts the temporary directory 115 to permanent storage 135 by renaming the temporary directory 115 such that it will persist upon the occurrence of the hardware and/or software failure.

Also note that such renaming described above may further identify the committed directory 145 as a version generated after the first directory 145 in order to allow a user to undo changes made by the multiple writes and rollback to the file(s) 120 in the first directory 145 version. Further, the renaming is typically based on the naming used for the first directory 145. For example, if the first directory was name “root path/Directory_V1”, then the new committed directory may be named “root path/Directory_V2” or something similar. As such, data of the file(s) within the committed directory 145 can potentially be modified in main memory and then used in subsequent file transactions. It is further noted that the path or root directory for the first directory 145, temporary directory 115, and/or committed directory 145 may be specified by a developer that created the file transaction system. Moreover, the temporary directory and/or committed directory 145 may automatically be determined based on the path specified for the first directory.

Note that in the event that only a portion of the multiple writes 130 are made to the file(s) 120 within the temporary directory 115 before the occurrence of a hardware and/or software failure, other embodiments may further include receiving a second initiate file transaction 105 at the transaction file manager 110 for making second multiple writes 130 to the file(s) 120. It may then be determined that the transaction abnormally terminated, which indicates that possibly not all writes 130 were made to the temporary directory 115 in order to maintain atomicity. Such abnormal termination may be due to a catastrophic hardware and/or software failure, or due to some other action such as a request to abort from the application or user. As such, the temporary directory 115 may be deleted to remove inconsistent files and preserve atomicity thereof.

Note that often times during catastrophic hardware and/or software failures, the temporary directory 115 will automatically be lost; and therefore the transaction file manager 110 automatically allows execution of new transactions even though the previous transaction did not succeed. The difference from the previous case is that the temporary files from the prior transaction were removed due to the abnormal termination itself.

FIG. 4 illustrates a flow diagram for a method 400 of providing multiple levels of undo/redo functionality for changes to document(s) without regard to any particular document format type by using a sortable directory mechanism. Method 400 includes an act for receiving 405 user input requesting an undo/redo change to a set of files. For example, transaction file manager 110 may receive a request from a user to perform an undo/redo to changes that have been committed to store 135 for a particular set of files 120. Thereafter, method 400 further includes an act for accessing 410 a set of directories related to the set of files. For example, transaction file manager 110 may access a set of directories 145 (e.g., “Directory_Vxx”, which may include Directory_V1 260, Directory_V2 265, and Directory_V3 270, etc.) related to the files 120, wherein each of the set of directories 145 includes an atomic set of the files 120 that were committed to permanent storage 135 such that each directory (e.g., Directory_V1 260, Directory_V2 265, and Directory_V3 270) within the set 145 represents a version of writes 130 that were atomically maintained across the set of files 120.

Based on the user input, method 400 also includes a step of selecting 415 a chosen directory from the set of directories for accessing a particular version of the set of files. For example, transaction file manager 110 may present the list of directory versions (e.g., Directory_V1 260, Directory_V2 265, and Directory_V3 270) for allowing a user to choose a particular version to revert to. Upon receiving the user input, the transaction file manager 110 selects the chosen directory 145 for allowing a user access to the files 120 of that particular version in order to apply multiple-levels of the undo/redo changes as desired. This chosen directory may then be renamed or otherwise marked to easily identify it as the chosen directory in subsequent transaction requests 105 for the set of files 120.

Note that such selections and presentations to the user may be based on time periods assigned to the chosen directory. In one embodiment, the exact time of the desired rollback may not be known; however, an approximate time value can be compared to the time values associated with the committed directories 145 for choosing a close approximation thereto. Typically, however, the selection of the chosen directory 145 will be based on a naming convention (e.g., “V_xx”), which represents an easily identifiable sorted order of the particular version of the set of files 120 that were committed to each of the set of directories 145. This naming convention may include numerical numbers for easily identifying the sorted order, or may use other sorting mechanisms such as alphabetical or other ordering.

Note that in other embodiments, the rollback feature may be based on other necessities. For example, a background task may run that looks for the existence of abnormally terminated files—i.e., by identifying temporary directories for which no current writes 130 are occurring. Accordingly, when a hardware/software failure causes the system to reboot or terminate a process, the temporary directories left around that contain partially written files can be cleaned up and/or otherwise deleted. Of course, as mentioned above, there may be other reasons and mechanisms by which the above rollback feature is advantageously used in accordance with embodiments herein.

FIG. 5 illustrates a flow diagram for a method 500 of ensuring atomicity across multiple writes to a set of documents in order to protect against hardware and/or software failures by rolling back to a previous version of the set of documents based on a transaction that only partially completed. Method 500 includes an act for receiving 505 an initialization of a file transaction for a set of files. For example, transaction file manager 110 may receive initiate file transaction 105 for files 120, which are atomically maintained such that a change to one file must either be consistently applied to each file within the set, or not at all.

Based on the initialization, method 500 also includes an act for accessing 510 a storage that includes temporary directory and first directory for different versions of the set of files. For example, upon receiving initiate file transaction 105, transaction file manager 110 can access a path or particular storage that includes temporary directory 115 and first or committed directory 145 for different versions of the set of files 120. Note that the temporary directory 115 was automatically created from a previous file transaction initialization 105 that made changes to one, but not all, of the files 120. The first directory 145, on the other hand, includes a copy of the set of files 120 without the change to any of the files 120.

Thereafter, method 500 includes an act for identifying 515 that the file transaction abnormally terminated, which indicates that at least one file within the temporary directory does not include the change. In other words, transaction file manager 110 uses the presence of the temporary directory 115 (or some other indication) to determine that the previous transaction terminated abnormally, which indicates that consistency and atomicity of writes 130 to files 120 cannot be guaranteed. Note that the abnormal termination (other than such things as a hardware/software failure) may be input received from a developer expressing a desire to not commit the transaction, but rather roll it back. That is, after the transaction start 105, but in lieu of transaction commit, the developer requests the rollback functionality of current embodiments. Of course, as previously mentioned, there may be other mechanisms and reasons for performing such rollback feature, such as a background operation for cleaning up non-committed files.

Method 500 then includes a step of using the first directory for the file transaction. In other words, the transaction file manager 110 rolls back to the previous transaction by typically deleting the temporary directory 115, which includes the version without the change to any of the files 120 within the set. When deleting the temporary directory 115, such deletion ensures that it is not considered in subsequent file 120 transactions and also that inconsistent temporary files in the file system created during the previous abnormally terminated transaction are removed. Note that the change or write 130 may be an addition of a file 120 to the set, and not just a modification to an existing file. In other words, between versions it is possible that the total number of files may not be the same due to the addition of other related files, which will also need to be synched. Also note that typically the temporary directory 115 and the first directory share a common root path.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. In a computing system configured to modify files, a method of ensuring atomicity for multiple writes across one or more documents without regard to any particular document format type and without creating complex code for syncing document fields, the method comprising:
receiving a file transaction initialization for making multiple writes to one or more files located within a first directory of a file system;
identifying the file transaction as requiring atomic consistency across the multiple writes to the one or more files such that the multiple writes either succeed or fail as a whole even with a hardware failure, software failure, or both; and
based on the required atomic consistency, automatically creating a temporary directory folder different from the first directory, the temporary directory created for saving in-memory data for the one or more files in order to make the multiple writes thereto.

2. The method of claim 1, wherein each of the multiple writes are made to the one or more files within the temporary directory, the method further comprising:
receiving a commit notification that converts the temporary directory to permanent storage by renaming the temporary directory such that it will persist upon the occurrence of the hardware failure, software failure, or both.

3. The method of claim 2, wherein the renaming further identifies the committed directory as a version generated after the first directory in order to allow a user to undo changes made by the multiple writes and rollback to the one or more files to the first directory version.

4. The method of claim 2, wherein the renaming is based on the naming of the first directory.

5. The method of claim 2, wherein data of the one or more files within the committed directory is modified in memory and used in one or more subsequent file transactions.

6. The method of claim 2, wherein a path to one or more of the first directory, temporary directory, or committed directory are specified by a developer that created the file transaction system.

7. The method of claim 2, wherein a path to temporary directory, committed directory, or both, is automatically determined based on a path specified for the first directory.

8. The method of claim 1, wherein only a portion of the multiple writes are made to the one or more files within the temporary directory before the occurrence of a hardware failure, software failure, or both, the method further comprising:
receiving a second file transaction initialization for making second multiple writes to the one or more files;
determining that the file transaction abnormally terminated; and
deleting the temporary directory to remove inconsistent files and preserve atomicity thereof.

9. The method of claim 8, wherein based on the second file transaction initialization, the method further comprises:
automatically creating a second temporary directory folder different from the first directory, the second temporary directory created for saving in-memory data for the one or more files in order to make the second multiple writes thereto.

10. In a computing system configured to modify files, a method of providing for multiple levels of undo/redo functionality for changes to the one or more documents without regard to any particular document format type by using a sortable directory mechanism, the method comprising:
receiving user input requesting an undo/redo change to a set of files, wherein the set of files are atomically maintained such that a change to one file must either be consistently applied to each file within the set, or not at all;
accessing a set of directories related to the set of files, wherein each of the set of directories includes an atomic set of the files that were committed to permanent storage such that each directory within the set represents a version of writes that were atomically maintained across the set of files; and
based on the user input, selecting a chosen directory from the set of directories for accessing a particular version of the set of files in order to apply multiple-levels of the undo/redo changes as desired.

11. The method of claim 10, wherein the selection of the chosen directory is based on a first time period assigned to the chosen directory for when its version of writes for the set of files were committed thereto.

12. The method of claim 11, wherein the user input identifies a second time period, and wherein the second time period is a closest approximation to the first time period associated with the set of directories.

13. The method of claim 10, wherein the selection of the chosen directory is based on a naming convention for the set of directories, which represents an easily identifiable sorted order of the particular version of the set of files that were committed to each of the set of directories.

14. The method of claim 13, wherein the naming convention includes at least numerical numbers for easily identifying the sorted order.

15. The method of claim 10, wherein the chosen directory is renamed or otherwise marked to easily identify it as the chosen directory in subsequent transaction requests for the set of files.

16. The method of claim 10, wherein a single root path is used for the set of directories.

17. In a computing system configured to modify files, a method of ensuring atomicity across multiple writes to a set of documents in order to protect against hardware or software failures by rolling back to a previous version of the set of documents based on a transaction that only partially completed, without creating complex code for syncing document fields, the method comprising:
receiving an initialization of a file transaction for a set of files, which are atomically maintained such that a change to one file must either be consistently applied to each file within the set, or not at all;
based on the initialization, accessing a storage that includes a temporary directory and a first directory for different versions of the set of files, wherein the temporary directory was automatically created from a previous file transaction initialization that made at least one change to at least one file from the set of files, and wherein the first directory includes a copy of the set of files without the at least one change to any file within the set;
identifying that the file transaction abnormally terminated, which indicates that at least one of the files from the set of files within the temporary directory does not include the at least one change such that the at least one change has not been consistently applied to each of the files within the set; and
using the first directory for the file transaction such that the set of files rolls-back to the version without the at least one change to any file within the set.

18. The method of claim 17, the method further comprising:
deleting the temporary directory such in order to ensure that the temporary directory is not considered in subsequent file transactions and to ensure that inconsistent temporary files created during the file transaction that abnormally terminated are removed.

19. The method of claim 17, wherein the at least one change is the creation of an additional file to the set of files.

20. The method of claim 17, wherein a single root path is used for both the first directory and the temporary directory for easily relating the two.
